(19) United States
(12) Patent Application Publication
(10) Pub. No.: US 2012/0059753 A1
(43) Pub. Date: Mar. 8, 2012

(54) SYSTEM AND METHOD FOR ELECTRONIC FINANCIAL EXCHANGE

(76) Inventor: Michael Weinstock, New York, NY (US)

(21) Appl. No.: 13/096,354

(22) Filed: Apr. 28, 2011

Related U.S. Application Data
(60) Provisional application No. 61/380,866, filed on Sep. 8, 2010.

(51) Int. Cl. G06Q 40/00

(52) U.S. Cl. 705/37

(57) ABSTRACT

A system and method for providing a financial exchange is disclosed. In an embodiment, at least one agreement term associated with collateral is received from a first computing device, as well as a request for at least one agreement that relates to the agreement term(s). At least one electronic agreement that includes terms for collateral, a financial amount, an interest rate and a termination date is transmitted to the first computing device. A selection of one agreement is received that represents a first commitment by the first counterparty to be bound to the terms of the agreement. An electronic commitment representing a second commitment is received from a second computing device, and electronic collateral information is received from the first computing device or from a third computing device. First payment information is received from the second computing device or from a fourth computing device.

### RELATED APPLICATION

This application is based on and claims priority to U.S. Provisional Patent Application Ser. No. 61/380,866, filed on Sep. 8, 2010 and entitled “SYSTEM AND METHOD FOR ELECTRONIC FINANCIAL EXCHANGE,” the entire contents of which are hereby incorporated by reference.

### BACKGROUND OF THE INVENTION

1. Field of the Invention

The present invention relates generally to financial transactions and, more particularly, to providing a market exchange for short term secured transactions.

2. Description of the Related Art

The repurchase agreement market, including repurchase agreements done “over the counter,” is one of the largest and most active sectors in the US money market, and in the world at large. Repurchase agreements are, typically, contracts for the sale and future repurchase of financial assets, most often governmental securities, such as Treasury Bills. In a typical arrangement involving a repurchase agreement, a seller of an asset sells an asset to a buyer for a predetermined price, and then repurchases the asset at a scheduled future date (termed a “termination date”) for the same price at which he sold it, plus interest.

Repurchase agreements are widely used for investing surplus funds in the short term, or for borrowing funds in the short term against collateral. Moreover, dealers in securities may use repurchase agreement arrangements for other reasons, including to manage liquidity, to finance inventories, or to speculate in various ways. The U.S. Federal Reserve uses repurchase agreement arrangements to manage aggregate reserves of the banking system.

Although a repurchase agreement is effectively a sequential pair of sales (an initial (first) sale of an asset and a repurchase (second) sale of the asset), a repurchase agreement may be more commonly be thought of as a short-term interest-bearing loan against collateral. The annualized rate of interest paid by the seller of the asset is known as the “repurchase agreement rate.”

Repurchase agreements may be defined for virtually any duration but most commonly occur overnight. Those repurchase agreements that are for longer than overnight are known as term repurchase agreements. There are also open repurchase agreements that can be terminated by either side on a day's notice. In common parlance, the seller of securities “does a repo” and the lender of funds “does a reverse.” Because money is the more liquid asset, the lender normally receives a margin on the collateral, meaning it is priced below market value, usually by 2, 6 to 5 percent depending on maturity.

The overnight repurchase agreement rate normally runs slightly below the Federal funds rate for two reasons. First a repurchase agreement transaction can be considered a secured loan, whereas the sale of Federal funds is an unsecured loan. Second, many who can invest in repurchase agreements cannot sell Federal funds. Even though the return is modest, overnight lending in the repurchase agreement market offers several advantages to investors. By rolling overnight repurchase agreements, investors can keep surplus funds invested without losing liquidity or incurring price risk. Investors also incur very little credit risk because the collateral is always high-grade paper.

The largest users of repurchase agreements and reverses are dealers in government securities. As of June 2008 there were 20 primary dealers recognized by the Federal Reserve, which means those dealers are authorized to bid on newly issued Treasury securities for resale in the market. Primary dealers must be well capitalized, and often deal in hundred million dollar chunks. In addition there are several hundred dealers who buy and sell Treasury securities in the secondary market and do repurchase agreements and reverses in at least one million dollar chunks.

The balance sheet of a government securities dealer is highly leveraged, with assets typically 50 to 100 times its own capital. To finance the inventory, there is a need to obtain repurchase agreement money in large amounts on a continuing basis. Big suppliers of repurchase agreement money are money funds, large corporations, state and local governments, and foreign central banks Generally the alternative of investing in securities that mature in a few months is not attractive by comparison. Even 3-month Treasury bills normally yield less than overnight repurchase agreements.

### SUMMARY

A system and method are disclosed for an electronic financial exchange and a standardized repurchase agreement contract that will be traded on it, thus allowing those who have cash and want to lend it an immediate and safe venue to do so and those who have collateral and want to borrow against it an immediate and safe venue to do so.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings several forms that are presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware and system arrangement in a preferred embodiment;

FIG. 2 illustrates the functional elements of an information processor and/or computing devices; and

FIG. 3 is a block diagram illustrating an example collection of counterparties interacting via an electronic financial exchange and information processor in accordance with an embodiment of the present application.

### DESCRIPTION OF THE EMBODIMENTS

In a preferred embodiment, a financial exchange is provided that employs standardized contracts for transactions that have attributes common to typical repurchase agreements. Many features of repurchase agreements are included in accordance with the present application including, for example, receiving commitments from each of the counterparties to sequentially exchange one or more assets for capital, and to exchange the same capital plus interest for the same assets, within a relatively short timeframe. Unlike typical repurchase agreements, however, the present application does not require a legal transfer of title of an asset between counterparties absent occurrence of some contingency event, such as a failure to maintain sufficient collateral or to realize a margin call. In the event of a borrower's failure to meet some prescribed goal, such as to repay the borrowed capital plus interest, the financial exchange of the present application may instruct the borrowing party's clearing firm to transfer title of the underlying collateral to the exchange to be liquidated or otherwise disposed, or to take some other action on the collateral in accordance with predetermined rules.

Thus and in preferred embodiments, no transfer of ownership rights takes place for many of the transactions that occur on the financial exchange of the present application. Underlying collateral is owned by the party that is borrowing capital and is preferably held by that borrowing party's clearing firm. Of course, some other party other than a clearing firm may hold the underlying collateral, including the financial exchange 103. For simplicity, the examples herein recite use of a counterparty's clearance firm as the holder of collateral during the term of a transaction agreement. In a preferred embodiment, even while the underlying collateral is held by the borrowing party's clearing firm, the borrowing party may still be entitled to any dividends/coupons associated with the underlying collateral.

In accordance with the teachings herein, the benefits associated with repurchase agreements are realized, without the negative or otherwise unwanted effects thereof. For example, lenders can realize a relatively high interest rate on a short-term loan, and can take comfort that the investments that lenders are making are safe and well collateralized. Borrowers can borrow money quickly and easily, while still maintaining benefits from their underlying collateral. By maintaining ownership interests in the underlying collateral, transparency is maintained, and counterparties are restricted from hiding toxic assets, such as on their balance sheets.

In an embodiment, revenue is generated in several ways by the exchange. For example, nominal fees may be charged for each transaction that takes place on the financial exchange, which may be a small percentage of the dollar value of each transaction. The percentage may vary depending upon different factors, such as the particular underlying collateral or class of security, or the reputations and credibility of the counterparties. Moreover, fees may be charged based upon the length of an agreement. For example, an agreement with a nine-month term may net more for the financial exchange than an agreement with a three-month term. Further revenue may be generated, such as via internet-based advertising revenue, as known in the art.

Preferably, the value of underlying collateral that is held by the borrowing party's clearing firm in accordance with transaction agreements in accordance with the teachings herein exceeds the value of the capital that is contributed by the lending party. The financial exchange according to the present application may require some excess percentage value (e.g., 20%) of the value of the capital to be held by the borrowing party's clearing firm to overcapitalize the loan. For example, the lending party loans $100,000 of capital, and the borrowing party's clearing firm has to put up $120,000 worth of the underlying capital. This margin amount (e.g., 20% of the value of the capital) may be required on the grounds that money is a more liquid asset than the underlying collateral, and ensures that the borrowing party is long in case, for example, some market condition occurs that lowers the value of the collateral or in case the borrower defaults. The present application supports various percentages that may be required for overcapitalizing a transaction, and which may be negotiated based on a respective class of security. Government obligations may be, for example, less expensive (requiring a lower margin) than private securities.

In an embodiment, the financial exchange of the present application maintains control over the kinds of assets that parties are allowed to trade, as well as the quantities thereof. For example, individual markets are permitted on all capital stocks that are represented by the Dow Jones Industrial Average and the S&P 500, as well as capital stocks that are actively traded on the NASDAQ stock market, and United States Treasury Securities and mutual funds. In one or more embodiments, various rules and/or restrictions may be developed and placed by the financial exchange of the present application, such as to limit transactions to a maximum of 100 capital stocks plus treasuries and certain mutual funds.

The electronic financial exchange in accordance with the teachings herein allows those counterparties who have capital and want to lend the capital in an immediate and safe venue to do so. Further, the electronic financial exchange enables those who have collateral and want to borrow against the collateral with an immediate and safe venue to do so. In an embodiment, the lending and borrowing are effected by standardized transaction agreements that include at least three variables: a monetary quantity variable; an expiration month; and an identifier of the collateral. The monetary quantity variable, generally, represents a multiplier of a minimum dollar amount, such as $1,000, of the transaction. For example, a variable of 100 refers to a transaction involving $100,000. The expiration month, generally, refers to the month when the transaction terminates. In an alternative embodiment, the actual expiration month may be a month that is a number of months before or after the actual expiration month. For example, the expiration month March may be three months before the actual expiration month, which may be June. The identifier indicates what the underlying collateral is, and may be expressed as a known stock symbol or other identifier. Moreover, each standardized agreement may include an interest rate, such as a percentage value. The interest rate is preferably bid on and/or offered, and may be included in the price of the transaction agreement.

Thus, for example, a transaction agreement in accordance with the teachings herein includes the variables “100” “jan” “aapl” “−0.02.” Provided that the base dollar value is $1,000, then the variables define a transaction that includes $100,000 (100*$1,000) worth of capital, terminates during the month of January, for APPLE INC. stock, at an interest rate of 2%. Continuing with this example and complying with the rules of the financial exchange, the borrower maintains a 20% margin of the underlying inventory and puts up $120,000 worth of APPLE INC. stock. If, over time, the value of the underlying collateral changes, for example, due to depreciation of the collateral, the borrower may need to provide more underlying collateral with the borrower's clearing firm.

As used herein, the terms, “buyer” and “lender” represents a party who has capital and lends the capital in accordance with a transaction agreement, substantially as described herein. As used herein, the terms, “seller” and “borrower” represents a party who has collateral and borrows capital in accordance with a transaction agreement, substantially as described herein.

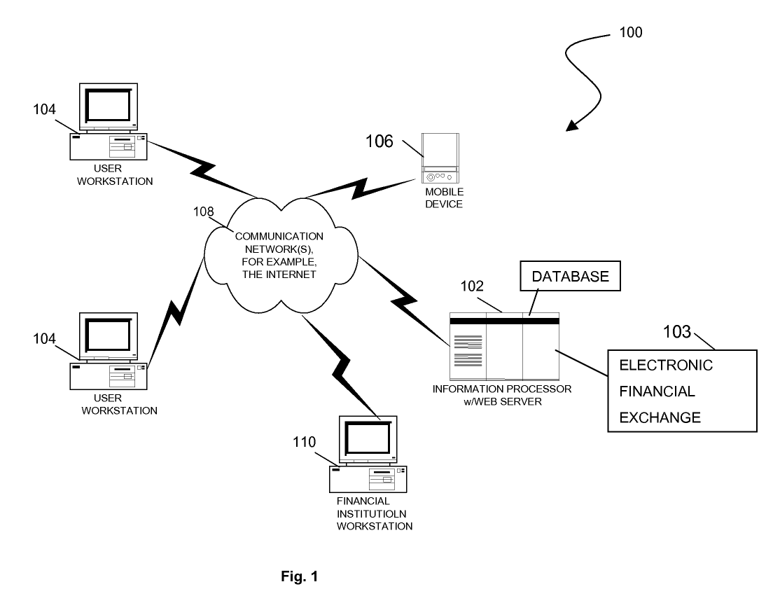

FIG. 1 shows an example hardware arrangement in accordance with an embodiment, referred to generally as system 100. In the embodiment shown in FIG. 1, system 100 comprises at least one information processor or server 102 that is operatively coupled to a database and that preferably manages or is configured to monitor financial exchange 103. Information processor 102 may also be configured to operate as an Internet web server, which provides additional functionality and operability for effecting transactions in accordance with the teachings herein. Information processor 102 may also be configured to interface with financial institution workstations 110, or otherwise manage financial accounts for counterparties engaged in transactions via the financial exchange set forth herein.

Information processor 102 is preferably configured to access communication network 108, and to communicate with various computing devices, including user workstations 104 and mobiles devices 106, which may be operated, for example, borrowers and lenders. Information processor 102 may further be configured to operate as a hypertext transport protocol (“HTTP”) Internet web server and/or a file transfer protocol (“FTP”) server to send and receive information, and to access and update the database.

Preferably, information processor 102 and computing devices 104, 106 communicate via the known communications protocol, Transmission Control Protocol/Internet Protocol (“TCP/IP”). In this way, content can be transmitted to and from the devices and commands can be executed to enable various kinds of functionality described herein.

Information processors 102 and computing devices 104, 106 are, depending on their configurations, any devices that are capable of sending and receiving data across communication network 108, including, for example, mainframe computers, mini computers, personal computers, laptop computers, netbook computers, personal digital assistants (PDA), mobile communication devices such as telephones and internet access devices. In addition, information processor 102 and computing devices 104, 106 may be equipped with one or more internet web browsers, such as MICROSOFT INTERNET EXPLORER, MOZILLA FIREFOX, SAFARI or the like. Thus and as envisioned herein, information processor 102 and/or computing devices 104, 106 are devices that can communicate over a network and can be operated anywhere, including, for example, from vehicles.

In a preferred embodiment, various kinds of input and output devices are utilized in system 100. Although many of the devices interface (e.g., connect) with a computer, it is envisioned herein that many of the devices can operate without any direct connection to a computer. Moreover, various so-called “peripheral” devices may be included in system 100 including, for example, imaging equipment (e.g., cameras), voice recording equipment and global positioning system (“GPS”) technology. Such peripheral devices may also send and receive data to and from information processor 102 and/or computing devices 104, 106.

The nature of the present invention is such that one skilled in the art of writing computer executable code (i.e., software) can implement the described functions using one or more of a combination of popular computer programming languages and development environments including, but not limited to C, C++, Visual Basic, JAVA, PHP, HTML, XML, ACTIVE SERVER PAGES, JAVA server pages, servlets, MICROSOFT.NET, and a plurality of various web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or more of a plurality of sources. In another example, data are received that are provided in a particular format (e.g., MICROSOFT EXCEL), and programming routines are executed that convert the data to another format (e.g., ASCII comma-delimited text).

It is contemplated herein that any suitable operating system can be used on information processor 102 and computing devices 104, 106 and, may be, for example, DOS, WINDOWS 3.x, WINDOWS 95, WINDOWS 98, WINDOWS 2000, WINDOWS VISTA, WINDOWS XP, WINDOWS 7, WINDOWS NT, MAC OS, UNIX, LINUX, PALM OS, POCKET PC, BLACKBERRY or any other suitable operating system. Further, the teachings herein support various programming languages and/or software development environment environments, such as JAVA, JAVA Script, Action Script, Swish, or the like. Moreover, a plurality of data file types is envisioned herein. For example, the present invention preferably supports various suitable multi-media types, including but not limited to JPEG, BMP, GIF, TIFF, MPEG, AVI, MP4, SWF, RAW or the like (as known to those skilled in the art).

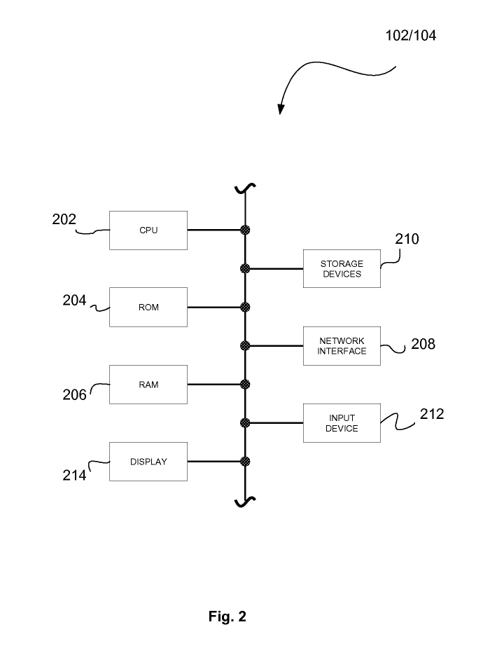

FIG. 2 illustrates the functional elements of an information processor 102 and/or computing devices 104, 106, which typically include one or more central processing units (CPU) 202 used to execute software code and control the operations of the devices, read-only memory (ROM) 204, random access memory (RAM) 206, one or more network interfaces 208 to transmit and receive data to and from other computing devices across the communication network, storage devices 210, such as a hard disk drive, floppy disk drive, tape drive, CD ROM, flash or other electronic memory, or other memory for storing program code, databases, application data and other data, one or more input devices 212 such as a keyboard, mouse, track ball, touch pad, touch screen, microphone, camera or the like, and a display 214.

The various components of information processor 102 and/or computing devices 104, 106 need not be physically contained within the same chassis or even located in a single location. For example, storage 210 may be located at a site that is remote from the remaining elements of information processor 102, and may even be connected to CPU 202 across communication network 108 via network interface 208. Information processor 102 preferably includes a memory equipped with sufficient storage to provide the necessary databases, forums, and other services, as well as acting as a web server for communicating hypertext markup language (HTML), FLASH, Action Script, Java, Active Server Pages, Active-X control programs to computing devices 104, 106. Information processor 102 is preferably arranged with components, for example, those shown in FIG. 2, that are suitable for the expected operating environment of information processor 102. The CPU(s) 202, network interface(s) 208 and memory and storage devices are selected to ensure that the capacities are arranged to accommodate expected demand.

In a preferred embodiment, a client software application is distributed and installed on one or more mobile computing devices 106, such as smart phones (e.g., BLACKBERRY, IPHONE, DROID or the like), personal digital assistants, or other mobile devices that can be carried by persons. In an embodiment, a person connects to a web site or other software distribution site, such as provided via information processor 102, and downloads a copy of the client software application to be installed on mobile device 106. In an alternative embodiment, the client software application is installed on a user workstation 104, which may be a desktop computer, notebook computer, netbook computer or other computer.

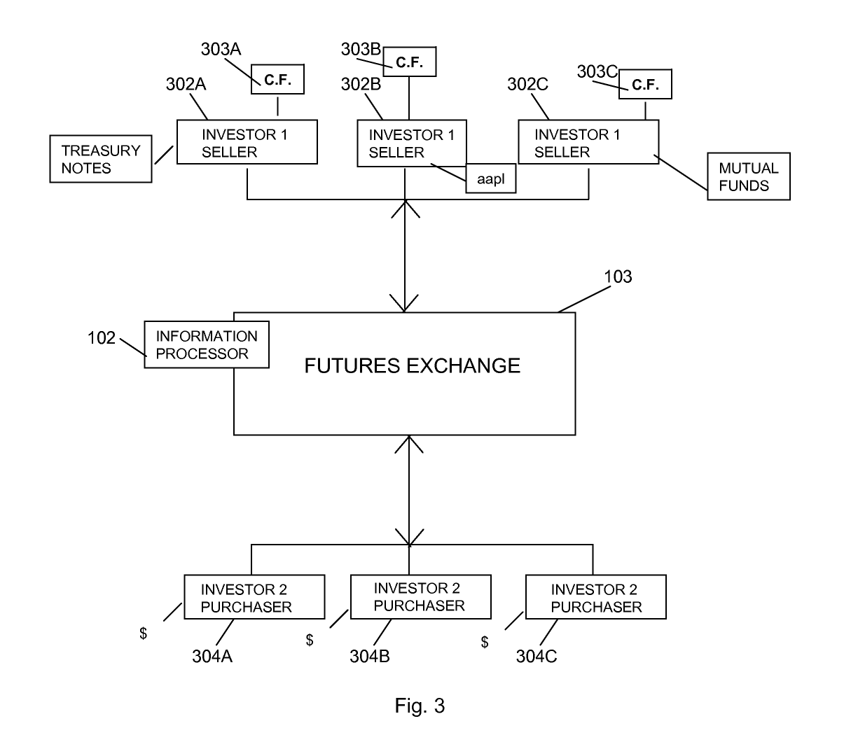

FIG. 3 is a block diagram illustrating an example collection of counterparties interacting via electronic financial exchange 103 and information processor 102 in accordance with an embodiment of the present application. As shown in FIG. 3, investors 302A, 302B and 302C are sellers (borrowers), and investors 304A, 304B and 304C are buyers (lenders). In the example shown in the FIG. 3, investor seller 302A has treasury notes as underlying collateral, investor 302B has APPLE INC. stock (represented as “aapl”), and investor seller 302C has mutual funds. The respective collateral is illustrated has being respectively held by clearance firms (“C.F.”) 303A, 303B and 303C. All of the investor buyers 304A, 304B and 304C have capital ($) to invest. At the center is electronic financial exchange 103, and managed/monitored via information processor 102.

A first example describing various features associated with an embodiment of the present application is now provided.

In the month of June, A hedge fund believes that APPLE INC. stock will be trading 300 by January. The hedge fund wants to allocate $120 million to buy APPLE INC. stock but the fund does not want that amount of money tied up for six months. Moreover, the hedge fund does not want to, or possibly cannot trade options.

Continuing with this example, APPLE INC. stock is trading $200 and is not selling (or moving) at all. The hedge fund purchases 600,000 shares of shares of APPLE INC. stock ($120 million/$200=600,000 shares) on the NASDAQ exchange for sale on electronic financial exchange 103. The hedge fund accesses information processor 102 and determines whether any transaction agreements for the APPLE INC. stock Jan is available. In this example, the hedge fund has accessed information processor 102 and has downloaded client software from information processor 102 that is installed and operates on hedge fund's mobile device 106. Once installed, the mobile device 106 is configured to interact with information processor 102, including to identify the status of one or more assets, as well as to enter into transactions with other counterparties via financial exchange 103.

Continuing with this example, the hedge fund determines that a Jan APPLE INC. stock transaction agreement is offered between −0.022 at −0.018, such that that one counterparty wants to lend capital at an interest rate of 2.2%, and another counterparty wants to borrow at an interest rate of 1.8%. Deciding to be competitive and to attract a lender 304, the hedge fund splits the middle and offers 100 k Jan APPLE INC. stock −0.020, and the offer is accepted (i.e., the hedge fund “gets lifted”). In accordance with rules set forth by the financial exchange 103, the hedge fund must own at least 120% of the value of the transaction agreement in the form of the underlying collateral in order to sell according to the transaction agreement. As noted above, in a preferred embodiment, a borrower 302 can only enter into (e.g., “sell”) financial exchange 103 transaction agreements if the borrower is initially long a predetermined amount, such as 120% of the corresponding value of the underlying.

Continuing with this example, the hedge fund's 600,000 shares (valued at $120 million) shares of APPLE INC. stock are held and “locked” (e.g., cannot be traded, sold, or the like) with the hedge fund's clearing firm. As noted above, notwithstanding the stock being locked by the hedge fund's clearing firm, the hedge fund remains the beneficial owner of the stock, and remains entitled to any dividend or coupon attached to the underlying collateral. The hedge fund is offsetting a long position and, accordingly, is desirous to have any stock locked and to remain a beneficial owner thereof. As note above, one benefit of this arrangement is to ensure transparency and to preclude parties, such as the hedge fund, from temporarily hiding toxic assets (e.g., bad loans) from its balance sheet.

Continuing with this example, once the counterparties to the transaction agreement commit, information processor 102 preferably executes commands to cause the hedge fund's financial account to be credited $100 million minus the interest (2%), for a total of $98 million. The hedge fund is short 100 k transaction agreements of Jan APPLE INC. stock at −0.020, and information processor 102 debits $120 million worth of APPLE INC. stock from the hedge fund. If the hedge fund maintains the terms of the transaction agreement until expiration (i.e., as controlled by the termination month), the hedge fund will be debited $100 million and its 600 k shares will be unlocked from the clearing firm, thereby effectively returning control of those shares to the hedge fund.

In the event that, for example, the price of APPLE INC. stock falls, then the total amount of shares of APPLE INC. stock that the hedge fund must own in accordance with the rules set forth by the financial exchange 103 may change. In the present example, the hedge fund must maintain at least $120 million worth of the APPLE INC. stock, and will get a margin call if the hedge fund's ownership drops below that amount.

Continuing with the present example, the lender 304 uses user workstation 104, 106 or the like and connects to information processor 102 to access the financial exchange 103. The lender 304 enters into (“buys”) 100 k transaction agreements of Jan APPLE INC. stock −0.020. Information processor 102 preferably debits $100 million minus the interest rate (2%), totaling $98 million of capital from the lender's 304 account. Information processor 102 further ensures that $120 million worth of APPLE INC. shares are obligated to them. As noted above, in case of the borrower's 302 default or other event, information processor 102 may instruct or otherwise cause the borrower's clearing firm to transfer the shares to the lender 304. This may be effected in various ways, including by the financial exchange 103 exercising a power of attorney over the APPLE INC. shares and assigning the shares to the lender 304. Alternatively, a third party, such as a legal representative hired by the financial exchange 103 or the clearing firm may exercise a power of attorney over the APPLE INC. shares to ensure that title to the shares is transferred from the borrower 302, accordingly.

Continuing with the present example, in case the transaction agreement expires as directed by the termination month set forth therein, the lender 304 receives $100 million of capital, and the $120 million worth of APPLE INC. shares are no longer reserved. The lender 304 that was originally debited $98 million receives $100 million, thereby realizing the 2% interest that was agreed upon in the original transaction agreement.

Thus and for example in accordance with a preferred embodiment, a lender during a transaction agreement is considered long, for example, 100 k Jan APPLE INC. stock −0.020 held until expiration. Thereafter, $120 million of APPLE INC. stock will no longer obligated to the lender and the lender's account will be credited $100 million. In this example, the borrower is considered short 100 k Jan APPLE INC. stock −0.020 held until expiration. Thereafter, $120 million of APPLE INC. stock will be returned to the borrower and the borrower's account will be debited $100 million.

A second example describing various features associated with an embodiment of the present application is now provided.

A lender 304 is bullish on IBM stock. The lender 304 uses the teachings herein to concentrate a plurality of loans by buying transaction agreements of the IBM stock. The lender 304 believes that the IBM stock will increase in value or at least stay where it is, thereby believing that the collateral is safe to invest in. Accordingly, the lender 304 enters into a transaction agreement with another counterparty for 10 k shares (valued at $10 million) Jan IBM stock −0.020 (at a 2% interest rate). The counterparties access information processor 102, which causes $12 million worth of shares of IBM stock to be obligated to the lender 304, and $10 million−2% ($9,800,000) to be debited from the lender's 304 financial account.

Continuing with the second example, three months into the term of the transaction agreement, the price of IBM stock has risen 10%. The lender 304 accesses information processor 102 and determines the cost for transaction agreements that are bought and sold on the financial exchange 103 has, accordingly, changed. For example, the cost of borrowing money in connection with a transaction agreement involving IBM stock as the underlying collateral has decreased, such that lenders 304 are willing to loan at an interest rate of 0.015 (i.e., 1.5%) and borrowers 302 in possession of IBM stock are asking to borrow at an interest rate of 0.010 (i.e., 1%). The lender 304, accordingly, “lifts” an offer involving IBM stock, and agrees to 10,0000 Jan IBM stock −0.015. Once completed, the 10,000 Jan IBM stock agreements effectively cancel each other, and the lender 304 is now “flat.” In effect, the lender 304 was long at −0.020 and then sold out of the position at −0.015 netting a 0.005 (0.05%) profit. Accordingly, $12 million worth of IBM shares are no longer obligated to the lender 304, and the lender's account is credited $10 million minus 1.5%=$9,850,000. The net result is less profit for the lender 304.

It will become apparent to one skilled in the art that, in a typical transaction agreement in accordance with the teachings herein, it may be most advantageous for lenders 304 to maintain transaction agreements until expiration. This is not a steadfast rule, however, as underlying collateral may be deemed to be much riskier than originally thought, or a lender 304 may become worried about risk of default. Alternatively, lenders 304 may simply need capital back before the designated expiration for various other reasons.

In accordance with the present application, the price of the underlying collateral does not determine the amount of money that actually changes hands. Instead, the price of the underlying collateral affects the number of shares that are being locked and obligated. Moreover, interest rates may be individually negotiated, as is the transaction agreement size, as well as the amount of money changing hands.

Continuing with the second example, alternatively after three months into the term of the transaction agreement, IBM stock drops 10%. In this case, the time decay would likely cancel out the perceived increased risk of having IBM stock for collateral. Also, the interest rate would likely be approximately what it was when the counterparties entered into the agreement. If the lender 304 terminates the agreement, and sells 10 k Jan IBM stock −0.020, the lender is credited $9.8 million capital and $12 million worth of IBM stock shares are no longer obligated to the lender. Effectively, the lender 304 is right back where the lender 304 started, minus possible fees owed to the financial exchange 103.

The present application is now described with reference to a third example.

A trader wants to be long $12 million of APPLE INC. stock but does not want to tie up that $12 million for an extended period of time. The trader believes that there are many other worthy investments that the trader could take advantage of with cheap credit. The trader purchases $12 million worth of APPLE INC. stock shares on the NASDAQ stock market, and then enters into a transaction agreement comprising 10,000 Jan APPLE INC. stock at −0.020 on the financial exchange 103. The trader's shares are locked and held with the trader's clearing firm, and the trader receives $9.8 million.

Continuing with the third example, three months pass and APPLE INC. stock is now trading 10% higher. The trader's investment is up 10%, so the trader decides to free his shares in order to sell them and realize the 10% gain. In this example, the cost of borrowing APPLE INC. stock has gone down due to time decay and perceived increased safety of it being used as collateral. Accordingly, the trader enters into another transaction agreement defined by 10,000 Jan APPLE INC. stock −0.015 on the financial exchange 103. The trader is flat Jan APPLE INC. stock: his shares put up for collateral are returned and the trader is debited $9.85 million from his account. If rates go down due to time decay and the price of the underlying appreciates, any borrower 302 who is short their transaction agreements would elect to repurchase them if the borrower had the cash on hand and was not generating a satisfactory return on the spread (e.g., the cost of borrowing versus the return on the money that is borrowed).

Continuing with the third example, alternatively after the three months have passed, APPLE INC. stock is trading down 10%. The trader may have instructed information processor that, in the event of a 10% drop in the stock value, a mental stop is to be placed. Accordingly, the trader sees where transaction agreements involving Jan APPLE INC. stock is trading on the financial exchange 103. It is likely that the time decay would lower the interest rate but, in this example, the APPLE INC. stock is now considered a riskier investment. Continuing with this example, the market is right around where it was when the lender 304 initially entered into the transaction agreements. The lender 304 sees the market for Jan APPLE INC. stock is −0.022 at −0.020 and elects to “lift” the offer and buys 10 k Jan APPLE INC. stock at −0.020. The lender 304 is “flat” Jan APPLE INC. stock: his $12 million worth of shares are unlocked and your account is debited $9.8 million.

The above third example illustrates what happens when one is short the transaction agreement and desires to get out before expiration. In this example the lender 304 paid nothing to borrow the $9.8 million because the lender 304 was able to sell the transaction agreements for the same rate at which he bought it. The hope, of course, is that what the lender 304 used that money to net a positive return that softened the blow of the 10% loss to your stock.

With regard to risk in accordance with the present application, there is effectively a chain of responsibility. The risk to the seller of the transaction agreement (i.e., the borrower 302) may be perceived to be very low. However, once the borrower 302 has access to the capital, the borrower has risk that a second (or other) investment may not net a positive return and the borrower may be unable to purchase back the right to the collateral. Alternatively, borrowers 302 may default on margin calls.

The risk to buyers of a transaction agreement (i.e., the lenders 304), the risk is also perceived to be minimal. Lenders 304 have rights to collateral and, in accordance with a preferred embodiment, the borrower's 302 clearing firm may be instructed to liquidate assets in order to satisfy the loan.

The risk to the clearing firms is similarly relatively low. The clearing firms have responsibility to ensure that margin requirements are met from the borrowers 302, and it is the clearing firm's responsibility to keep their clients in compliance with those requirements.

The risk to the financial exchange 103 is similarly minimal. The financial exchange 103, preferably, does not back loans. The lender 304 has to assume some risk, and the financial exchange 103 guarantees the lender 304 their collateral, handles the transaction mechanism, and is responsible for creating and maintaining the market place, matching trades, and collateral allocation.

The benefits of the present application apply to borrowers 302, lenders 304, clearing firms, the financial exchange 103. Companies are not able to hide toxic assets by swapping them out for something else for a specified period of time. Further, virtually any entity with capital cash can make instantaneous loans, backed with collateral, with merely the click of a mouse or other selection device. Similarly, anyone can borrow against his or her exchanged approved assets with the click of a mouse. Companies may choose to raise capital by borrowing against their stock rather than paying exorbitant fees to investment banks to help them issue bonds, which provides a much cheaper alternative. Further, banks will profit due to the higher rate of return on their loans and the lower costs associated with them.

The financial exchange 103 preferably offers the banks (or any qualified entity or individual with capital) a way to make instantaneous loans at higher interest rates than U.S. treasuries. Lenders 304 choose how much to lend, put in a bid for the rate, and choose the term of the loan (exp month). This results in no due diligence, no endless paperwork, no hassle, and no wait. The result is a structure that has benefits and features provided by typical repurchase agreements, but eliminates the disadvantages thereof. Thus, the present application is not merely a mechanism for a classic repurchase agreement.

The present application has many advantages over known exchanges. One benefit is that trades can be made at tremendous speeds, with instantaneous activity occurring resulting in a virtually immediate raising of capital, or lending of capital at a relatively high rate of return. Further, the financial exchange 103 ensures full knowledge of collateral, thereby ensuring transparency that is otherwise unknown.

Moreover, transaction agreements are standardized, thereby ensuring accuracy and further can be provided in small units. This makes trading on the financial exchange 103 accessible to a plurality of borrowers 302, which also provides an advantage for brokers who can arrange for many transactions and earn commissions thereon. Further, the present application is preferably provided in a modular way, such that various features described herein may be combined as desired to maximize return and minimize loss for all parties involved in one or more transactions.

Further, interest rates are preferably negotiated, and may vary depending upon the monetary value of the transactions. For example, trades may involve various types: trades in the thousands of dollars; trades in the hundreds of thousands, trades in the millions, and trades in the tens of millions. The financial exchange 103 in accordance with an embodiment can support a bundle of such trades, each having respective interest amounts. Moreover, interest rates may be allowed to fluctuate, even during the life of a single transaction agreement depending upon one or more conditions (e.g., the value of the collateral). By providing for sophisticated automation, information processor 102 can manage the trades instantaneously, and calculate fees, interest, margins or the like for the respective parties.

Moreover, convenient user interfaces are preferably provided for various parties, including borrowers 302, lenders 304, clearing firms, financial exchange administrators or the like. By providing respective interfaces, users can easily maintain accurate records and can easily and quickly monitor the status of many different variables, such as described herein. Also, providing accessible information conveniently, parties to transactions can negotiate more fairly and openly. For example, a borrower 302 can review offers from other borrowers 302 and/or lenders 304 for transaction agreements involving different kinds of underlying collateral, amounts and interest rates, thereby enabling the borrow to make a competitive offer that has a realistic chance of getting lifted. To increase the speed of transactions, drop-down lists, radio buttons, push buttons or other graphic controls may be provided in user interfaces that enable counterparties to enter into transaction agreements with a single keystroke. Various protocols are preferably defined to effect the various trades, and which may limit the ability for parties to trade in order to reduce risk, ensure compliance, and increase net profits for all.

It is envisioned that many transaction agreement offers may be submitted by counterparties. The offers may concern various kinds of collateral, various amounts, various interest rates and various terms. Preferably, information processor 102 receives and stores each of the offers in one or more databases. By providing standardization, information can be formatted for displaying the terms of a transaction agreement offer in a single line (or in other convenient ways). Counterparties can review the single line and, thereafter, select one or more controls (e.g., a button) to accept or reject the terms. In some cases, no negotiation between the counterparties takes place and the proposed terms are either accepted or rejected. In other cases, interfaces are provided for counterparties to receive transaction offers, and then to propose modifications to one or more of the terms, such as the interest rate, amount of the transaction or the term. The modified proposal may then be sent back to the offering counterparty, and additional negotiations may take place. Alternatively, the modified terms may simply be accepted or rejected by the offering counterparty. Various degrees of customization may be provided for parties to negotiate terms in accordance with the present application.

In an embodiment, counterparties define one or more conditions or terms that represent acceptable transactions. Information processor 102, workstation 104 and/or mobile device 106, thereafter, search through multitudes of posted transaction offers from other counterparties to determine whether a suitable match is available. If so, then a trade may take place substantially without any further human intervention, as the computers determine that the terms are agreed upon, and then effect the trades. Thereafter, the counterparties are notified that a transaction agreement has be completed.

In some cases, a single transaction agreement offer may not satisfy all of the terms and conditions defined by a respective counterparty. It may be, however, that a plurality of transaction agreement offers may collectively satisfy those terms and conditions set forth by the counterparty. In that case, information processor 102 and/or devices 104/106 may effect a plurality of transaction agreements without additional human intervention, and the counterparties are notified of the completed transaction agreements. Preferably, information processor 102 supplies the counterparties with detailed reports identifying the combination of transaction agreements, and identifies the way that the combination of agreements collectively satisfy the terms and conditions initially set forth by one or more of the counterparties.

Thus, the electronic financial exchange 103 provides a very powerful way to effect many transactions instantaneously and in ways that were heretofore unavailable. By monitoring thousands or millions of transaction agreement offers and by combining the agreements to effect transactions that satisfy predefined and preferred conditions, trades can take place safely and immediately even without any human intervention. Alternatively and by providing standardization, parties can review at a glance a single line displaying trade terms in transaction agreement offers, and can then accept or reject the offers with a single press of a button. Moreover, interfaces are provided for those parties that desire to enter into negotiations with each other for any one or more terms of a transaction agreement offer.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for a financial exchange, the method comprising:
storing, on one or more processor readable media operatively coupled to one or more processors, at least one database that includes:
electronic counterparty information representing a plurality of counterparties; and
electronic agreement information representing at least terms for agreements between the plurality of counterparties;
providing, to at least one computing device, electronic instructions that program and configure the at least one computing device with an electronic user interface, to at least communicate with the one or more processors over a communication network, and to receive electronic information from the one or more processors;
receiving, via the electronic user interface and from a first computing device operated by a first counterparty, at least one agreement term associated with collateral and a request for at least one agreement that relates to the at least one agreement term;
providing, by the one or more processors, at least one electronic agreement associated with the at least one agreement term and at least some of the electronic agreement information stored in the database, wherein each of the at least one electronic agreement includes respective terms for at least collateral, a financial amount, an interest rate and a termination date;
transmitting, via the electronic user interface, the at least one electronic agreement to the first computing device;
receiving, from the first computing device via the electronic user interface, a selection of one of the at least one electronic agreement, wherein the selection represents a first commitment by the first counterparty to be bound to the terms of the one electronic agreement;
receiving, from a second computing device operated by a second counterparty, an electronic commitment representing a second commitment by the second counterparty to be bound to the terms of the one electronic agreement;
receiving, from the first computing device or from a third computing device, first electronic collateral information representing that the collateral is reserved for the second counterparty; and
receiving, from the second computing device or from a fourth computing device, first electronic financial payment information representing that the financial amount minus a predetermined amount has been debited from the second counterparty and credited to the first counterparty, wherein the predetermined amount is based on at least the interest rate.

2. The method of claim 1, wherein the first electronic collateral information is provided from a clearing house.

3. The method of claim 1, further comprising transmitting an electronic order to at least one financial institution to debit the financial amount minus the predetermined amount from a financial account held by the second counterparty.

4. The method of claim 1, further comprising receiving, from the second computing device or the fourth computing device, second electronic financial payment information representing that the financial amount has been credited to the second counterparty by the termination date; and
receiving, from the first computing device or the third computing device, second electronic collateral reservation information representing that the collateral is no longer reserved for the second counterparty.

5. The method of claim 4, wherein the second electronic collateral information is provided from a clearing house.

6. The method of claim 4, wherein the second electronic financial information further represents that the financial amount has been debited from the first counterparty.

7. The method of claim 1, wherein the first electronic collateral information further represents that the value of the collateral exceeds the financial amount by a predetermined percentage.

8. The method of claim 1, further comprising transmitting to the first computing device or the third computing device, an electronic margin instruction to increase the amount of collateral to equal the financial amount plus a predetermined percentage of the financial value.

9. The method of claim 1, wherein the providing the at least one electronic agreement further comprises selecting, by the one or more processors, the at least some of the electronic agreement information from the at least one database that matches the at least one agreement term.

10. The method of claim 1, wherein the providing the at least one electronic agreement further comprises selecting, by the one or more processors, the at least some of the electronic agreement information from the at least one database that relates to the at least one agreement term.

11. The method of claim 10, wherein the at least one agreement term is not included in the at least some of the electronic agreement information.

12. A method for a financial exchange, the method comprising:
storing, on one or more processor readable media operatively coupled to one or more processors, at least one database that includes:
electronic counterparty information representing a plurality of counterparties; and
electronic agreement information representing at least terms for one or more agreements between the plurality of counterparties;
providing, to at least one computing device, electronic instructions that program and configure the at least one computing device with an electronic user interface, to at least communicate with the one or more processors over a communication network, and to receive electronic information from the one or more processors;
receiving, via the electronic user interface and from a first computing device operated by a first counterparty, at least one agreement term associated with a financial amount, and a request for at least one agreement that relates to the at least one agreement term;
providing, by the one or more processors, at least one electronic agreement associated with the at least one agreement term and at least some of the electronic agreement information stored in the database, wherein each of the at least one electronic agreement includes respective terms for at least collateral, the financial amount, an interest rate and a termination date;
transmitting, via the electronic user interface, the at least one electronic agreement to the first computing device;
receiving, from the first computing device via the electronic user interface, a selection of one of the at least one electronic agreement, wherein the selection represents a first commitment by the first counterparty to be bound to the terms of the one electronic agreement;
receiving, from a second computing device operated by a second counterparty, an electronic commitment representing a second commitment by the second counterparty to be bound to the terms of the one electronic agreement;
receiving, from the second computing device or from a third computing device, first electronic collateral information representing that the collateral is reserved for the second counterparty; and
receiving, from the first computing device or from a fourth computing device, first electronic financial payment information representing that the financial amount minus a predetermined amount has been debited from the second counterparty and credited to the first counterparty, wherein the predetermined amount is based on at least the interest rate.

13. The method of claim 12, further comprising receiving, from the first computing device or from the fourth computing device, second electronic financial payment information representing that the financial amount has been credited to the first counterparty by the termination date; and
receiving, from the second computing device or the third computing device, second electronic collateral reservation information representing that the collateral is no longer reserved for the first counterparty.

14. A method for a financial exchange, the method comprising:
a) storing, on one or more processor readable media operatively coupled to one or more processors, at least one database that includes:
i) electronic counterparty information representing a plurality of counterparties;
ii) electronic asset information representing a plurality of assets; and
iii) electronic agreement information representing at least terms for at least one agreement between at least two counterparties;
b) providing, to a plurality of computing devices, electronic instructions that program and configure the plurality of computing devices with an electronic user interface, to at least communicate with the one or more processors over a communication network, and to receive electronic information from the one or more processors;
c) receiving from a first computing device configured with the electronic user interface and operated by a first counterparty, first electronic agreement information that represents at least collateral;
d) receiving, from a second computing device configured with the electronic user interface and operated by a second counterparty, second electronic agreement information that represents at least a financial amount;
e) generating, by the one or more processors, based on at least the first and second electronic agreement information and the electronic agreement information stored in the at least one database, a first electronic agreement that includes at least some of the first and second agreement information, an interest rate and a termination date;
f) transmitting, via the one or more communication devices and to the first and second computing devices, the first electronic agreement;
g) receiving, via the electronic user interface from the first computing device, or from a third computing device, first electronic collateral reservation information representing that the collateral is reserved for the second counterparty;
h) receiving, via the electronic user interface from the second computing device or from a fourth computing device, first electronic financial payment information representing that the financial amount minus a predetermined amount has been debited from the second counterparty and credited to the first counterparty, wherein the predetermined amount is based on at least the interest rate;
i) receiving, via the electronic user interface from the second computing device or from the fourth computing device, second electronic financial payment information representing that the financial amount has been debited from the first counterparty and credited to the second counterparty by the termination date; and
j) receiving, via the electronic user interface from the first computing device or the third computing device, second electronic collateral reservation information representing that the collateral is no longer reserved for the second counterparty.

15. A system for providing a financial exchange, the system comprising:
at least one database stored on one or more processor readable media operatively coupled to one or more processors, wherein the at least one database includes:
i) electronic counterparty information representing a plurality of counterparties;
ii) electronic asset information representing a plurality of assets; and
iii) electronic agreement information representing at least terms for at least one agreement between at least two counterparties;
wherein the one or more processor readable media further include electronic instructions that cause the one or more processors to:
program and configure the plurality of computing devices with an electronic user interface, to at least communicate with the one or more processors over a communication network, and to receive electronic information from the one or more processors;
receive from a first computing device configured with the electronic user interface and operated by a first counterparty, first electronic agreement information that represents at least collateral;
receive, from a second computing device configured with the electronic user interface and operated by a second counterparty, second electronic agreement information that represents at least a financial amount;
generate, based on at least the first and second electronic agreement information and the electronic agreement information stored in the at least one database, a first electronic agreement that includes at least some of the first and second agreement information, an interest rate and a termination date;
transmit, to the first and second computing devices, the first electronic agreement;
receive, via the electronic user interface from the first computing, or from a third computing device, first electronic collateral reservation information representing that the collateral is reserved for the second counterparty;
receive, via the electronic user interface from the second computing device or from a fourth computing device, first electronic financial payment information representing that the financial amount minus a predetermined amount has been debited from the second counterparty and credited to the first counterparty, wherein the predetermined amount is based on at least the interest rate;
receive, via the electronic user interface from the second computing device or from the fourth computing device, second electronic financial payment information representing that the financial amount has been debited from the first counterparty and credited to the second counterparty by the termination date; and
receive, via the one or more communication devices, via the electronic user interface from the first computing device or the third computing device, second electronic collateral reservation information representing that the collateral is no longer reserved for the second counterparty.
